(19) United States
(12) Patent Application Publication
(10) Pub. No.: US 2025/0215225 A1
(43) Pub. Date: Jul. 3, 2025

(54) A METHOD FOR THE PREPARATION OF A MEMBRANE (M) COMPRISING A SULFONATED POLY(ARYLENE ETHER SULFONE) POLYMER (SP) AND A NON-SULFONATED POLY(ARYLENE SULFONE) POLYMER (P)

(71) Applicant: BASF SE, Ludwigshafen am Rhein (DE)

(72) Inventors: Oliver GRONWALD, Ludwigshafen am Rhein (DE); Christian MALETZKO, Ludwigshafen am Rhein (DE); Martin WEBER, Ludwigshafen am Rhein (DE)

(21) Appl. No.: 18/851,738

(22) PCT Filed: Mar. 27, 2023
(86) PCT No.: PCT/EP2023/057852

§ 371 Date: Sep. 27, 2024

(30) Foreign Application Priority Data
Mar. 30, 2022 (EP) 22165543.4

(51) Int. Cl. C08L 81/06; B01D 61/14; B01D 67/00; B01D 69/02; B01D 71/68; C02F 1/44; C08J 9/26; C08J 9/28

(52) U.S. Cl. CPC C08L 81/06; B01D 61/145; B01D 67/0011; B01D 67/0013; B01D 69/02; B01D 71/68; C02F 1/444; C08J 9/26; C08J 9/283; B01D 2325/022; B01D 2325/34; C08J 2201/0464; C08J 2201/0502; C08J 2381/06; C08J 2481/06; C08L 2205/025

(57) ABSTRACT

The present invention relates to a method for the preparation of a membrane (M), the membrane (M) comprising a sulfonated poly(arylene ether sulfone) polymer (sP) and a non-sulfonated poly(arylene sulfone) polymer (P), to the membrane (M) obtained by the method and to the use of the membrane (M) as ultrafiltration membrane and/or for haemodialysis applications.

The present invention relates to a method for the preparation of a membrane (M), the membrane (M) comprising a sulfonated poly(arylene ether sulfone) polymer (sP) and a non-sulfonated poly(arylene sulfone) polymer (P), to the membrane (M) obtained by the method and to the use of the membrane (M) as ultrafiltration membrane and/or for haemodialysis applications.

Poly(arylene ether sulfone) polymers are high-performance thermoplastics in that they feature high heat resistance, good mechanical properties and inherent flame retardancy (E. M. Koch, H.-M. Walter, Kunststoffe 80 (1990) 1146; E. Döring, Kunststoffe 80, (1990) 1149, N. Inchaurondo-Nehm, Kunststoffe 98, (2008) 190). They are highly biocompatible and so are used as material for forming dialysis (N. A. Hoenich, K. P. Katapodis, Biomaterials 23 (2002) 3853) and ultrafiltration (UF) membranes. Ultrafiltration membranes (UF) are supposed to have an active filtration layer possessing a molecular weight cut-off from 10 to 100 kDa corresponding to 10 to 30 nm pore size to remove yeast, bacteria, virus and macromolecules efficiently from water.

The poly(arylene ether sulfone) membranes are usually prepared by a process comprising two steps: In a first step, a solution is provided, wherein the solution comprises the poly(arylene ether sulfone), a pore forming additive and a solvent; in the second step, the pore forming additive and the solvent are separated from the solution to obtain the poly(arylene ether sulfone) membrane. As water-soluble poly(vinyl pyrrolidone) also improves the viscosity of the solution, it is often added to a poly(arylene ether sulfone) solution as pore forming additive (S. Munari et al., Desalination 70 (1988) 265). Furthermore, for haemodialysis (HD) applications, remaining quantities of poly(vinyl pyrrolidone) in the active filtration layer inhibit the adhesion of serum protein and platelets to the membrane surface.

WO 2017/220363 A1 discloses a use of a membrane M comprising at least one sulfonated polyarylene ether A for removing arsenic compounds AS from aqueous systems, wherein said membrane M is an ultrafiltration or microfiltration membrane with a molecular weight cut-off of at least 2,500 Da.

US 2018/0345230 A1 discloses a transport membrane comprising a nanoporous polyethersulfone/polyvinylpyrrolidone blend support membrane, a hydrophilic polymer inside nanopores of said support membrane, a hydrophilic polymer coating layer on a surface of the support membrane and metal salts in said hydrophilic polymer coating layer and in said hydrophilic polymer inside said nanopores of said support membrane.

U.S. Pat. No. 5,246,582 discloses a synthetic hydrophilic membrane in the form of hollow fibers or flat membranes, comprising a mixture within a single layer of polysulfone and sulfonated polysulfone, wherein the mixture comprises ranges providing properties for dialysis and/or ultrafiltration from about 65 to about 95 wt % sulfonated polysulfone and from about 5 to about 35 wt % unsulfonated polysulfone.

In the article “Effect of Molecular Weight of Sulfonated Poly(ether sulfone) (SPES) on the Mechanical Strength and Antifouling Properties of Poly(ether sulfone)/SPES Blend Membranes” by L.-F. Fang et al. (Ind. Eng. Chem. Res., 2017, 56, 11302), the effect of molecular weights of sulfonated poly(ether sulfone) on the performance of a poly(ether sulfone)/SPES blend membrane is investigated. With the increase of molecular weight of SPES, the mechanical strength of the membranes is increased.

The article “The influence of sulfonated polyethersulfone (SPES) on surface nano-morphology and performance of polyethersulfone (PES) membrane” by A. Rahimpour et al. (Appl. Surf. Sci., 2010, 256, 1825) describes the sulfonation of polyethersulfone (PES) and the preparation of polyethersulfone (PES)/sulfonated polyethersulfone (SPES) blend membranes by immersion precipitation technique, wherein PVP is added as pore former.

However, due to its water solubility, poly(vinyl pyrrolidone) is easily eluted/leached from the membrane and, therefore, reduces the biocompatibility of the dialyzer membrane and compromises patient safety during HD therapy (M. Miyata et al., ASAIO Journal (2015) 468).

The object of the present invention, therefore, was to provide an improved poly(arylene ether sulfone) membrane, which exhibits a reduced poly(vinyl pyrrolidone) leaching. The membrane should also show a low molecular weight cut-off and a high water permeation. The method for the preparation of the membrane should be easy to perform at relatively low costs.

This object is achieved by a method for the preparation of a membrane (M), the membrane (M) comprising
(A) a sulfonated poly(arylene ether sulfone) polymer (sP) and
(B) a non-sulfonated poly(arylene sulfone) polymer (P),
wherein the method comprises at least steps a) and b):
a) providing a solution(S) which comprises the sulfonated poly(arylene ether sulfone) polymer (sP) according to component (A), the non-sulfonated poly(arylene sulfone) polymer (P) according to component (B), at least one pore forming additive (C) and at least one solvent (D), wherein the at least one pore forming additive (C) comprises poly(vinyl pyrrolidone), and
b) separating the at least one pore forming additive (C) and the at least one solvent (D) from the solution(S) to obtain the membrane (M).

This object is further achieved by a method for the preparation of a membrane (M), the membrane (M) comprising
(A) a sulfonated poly(arylene ether sulfone) polymer (SP) and
(B) a non-sulfonated poly(arylene sulfone) polymer (P),
wherein the method comprises at least steps a) and b):
a) providing a solution(S) which comprises the sulfonated poly(arylene ether sulfone) polymer (sP) according to component (A), the non-sulfonated poly(arylene sulfone) polymer (P) according to component (B), at least one pore forming additive (C) and at least one solvent (D), wherein the at least one pore forming additive (C) comprises poly(vinyl pyrrolidone), and
b) separating the at least one pore forming additive (C) and the at least one solvent (D) from the solution(S) to obtain the membrane (M),
   wherein the solution(S) in step a) comprises from 0.5 to 20% by weight of the sulfonated poly(arylene ether sulfone) polymer (sP), from 0.5 to 20% by weight of the non-sulfonated poly(arylene sulfone) polymer (P), from 3 to 20% by weight of the at least one pore forming additive (C) and from 40 to 96% by weight of the at least one solvent (D), based in each case on the total weight of the solution(S).

It has, surprisingly, been found that the membranes (M) prepared by the inventive method and comprising a sulfonated poly(arylene ether sulfone) polymer (sP) exhibit increased poly(vinyl pyrrolidone) (PVP) contents (PVPₜₒₜₐₗ and PVP_{surface}) which means that the inventive membranes (M) withhold poly(vinyl pyrrolidone) in the membrane matrix, and, therefore, prevent the leaching out of poly(vinyl pyrrolidone) off the membrane matrix. Furthermore, the inventive membranes (M) all show a high pure water permeation of >50 kg/(h m² bar) and a molecular weight cut-off (MWCO) of 11.2 to 30 kDa.

The present invention will be described in more detail hereinafter.

### Method for the Preparation of the Membrane (M)

By the inventive method comprising at least steps a) and b), a membrane (M) is prepared.

In the context of the present invention, the term “membrane” means a semipermeable structure capable of separating two fluids or separating molecular and/or ionic components or particles from a liquid. Thus, a membrane acts as a selective barrier, allowing some particles, substances or chemicals to pass through, while retaining others. The membrane may have various geometries such as flat sheet, spiral wound, pillows, tubular, single bore hollow fiber or multiple bore hollow fiber.

Preferred are flat sheet and hollow fibre membranes.

The membrane (M) is prepared by a method comprising at least the steps a) and b):
a) providing a solution(S) which comprises the sulfonated poly(arylene ether sulfone) polymer (sP) according to component (A), the non-sulfonated poly(arylene sulfone) polymer (P) according to component (B), at least one pore forming additive (C) and at least one solvent (D), wherein the at least one pore forming additive (C) comprises poly(vinyl pyrrolidone), and
b) separating the at least one pore forming additive (C) and the at least one solvent (D) from the solution(S) to obtain the membrane (M).

### Step a)

In step a), a solution(S) which comprises the sulfonated poly(arylene ether sulfone) polymer (sP) according to component (A), the non-sulfonated poly(arylene sulfone) polymer (P) according to component (B), at least one pore forming additive (C) and at least one solvent (D) is provided, wherein the at least one pore forming additive (C) comprises poly(vinyl pyrrolidone).

“At least one pore forming additive” within the context of the present invention means precisely one pore forming additive, and also a mixture of two or more pore forming additives.

“At least one pore forming additive, wherein the at least one pore forming additive (C) comprises poly(vinyl pyrrolidone)” within the context of the present invention means that the pore forming additive can consist of poly(vinyl pyrrolidone) or can comprise poly(vinyl pyrrolidone) and at least one further pore forming additive.

Another object of the present invention is therefore also a method for the preparation of a membrane (M), wherein the at least one pore forming additive (C) consists of poly(vinyl pyrrolidone).

“At least one solvent” within the context of the present invention means precisely one solvent, and also a mixture of two or more solvents.

The solution(S) in step a) can be provided by any method known to the skilled person. For example, the solution(S) can be provided in step a) in customary vessels that may comprise a stirring device and preferably a temperature control device. Preferably, the solution(S) is provided by dissolving the sulfonated poly(arylene ether sulfone) polymer (sP), the non-sulfonated poly(arylene sulfone) polymer (P) and the at least one pore forming additive (C), wherein the at least one pore forming additive (C) comprises poly(vinyl pyrrolidone), in the at least one solvent (D).

The dissolution of the sulfonated poly(arylene ether sulfone) polymer (sP), the non-sulfonated poly(arylene sulfone) polymer (P) and the at least one pore forming additive (C), wherein the at least one pore forming additive (C) comprises poly(vinyl pyrrolidone), in the at least one solvent (D) to provide the solution(S) is preferably effected under agitation.

Step a) is preferably carried out at elevated temperatures, especially in the range from to 100° C., more preferably in the range from 40 to 80° C. A person skilled in the art will choose the temperature in accordance with the at least one solvent (D).

The solution(S) preferably comprises the sulfonated poly(arylene ether sulfone) polymer (sP), the non-sulfonated poly(arylene sulfone) polymer (P) and the at least one pore forming additive (C), wherein the at least one pore forming additive (C) comprises poly(vinyl pyrrolidone), completely dissolved in the at least one solvent (D). This means that the solution(S) preferably comprises no solid particles of the sulfonated poly(arylene ether sulfone) polymer (sP), the non-sulfonated poly(arylene sulfone) polymer (P) and the at least one pore forming additive (C), wherein the at least one pore forming additive (C) comprises poly(vinyl pyrrolidone). Therefore, the sulfonated poly(arylene ether sulfone) polymer (sP), the non-sulfonated poly(arylene sulfone) polymer (P) and the at least one pore forming additive (C), wherein the at least one pore forming additive (C) comprises poly(vinyl pyrrolidone), preferably cannot be separated from the at least one solvent (D) by filtration.

The solution(S) can comprise from 0.5 to 25% by weight of the sulfonated poly(arylene ether sulfone) polymer (sP), from 0.5 to 25% by weight of the non-sulfonated poly(arylene sulfone) polymer (P), from 3 to 30% by weight of the at least one pore forming additive (C) and from 20 to 96% by weight of the at least one solvent (D), based in each case on the total weight of the solution(S).

Preferably, the solution(S) comprises from 0.5 to 20% by weight of the sulfonated poly(arylene ether sulfone) polymer (sP), from 0.5 to 20% by weight of the non-sulfonated poly(arylene sulfone) polymer (P), from 3 to 20% by weight of the at least one pore forming additive (C) and from 40 to 96% by weight of the at least one solvent (D), based in each case on the total weight of the solution(S).

Another object of the present invention is therefore also a method for the preparation of a membrane (M), wherein the solution(S) in step a) comprises from 0.5 to 20% by weight of the sulfonated poly(arylene ether sulfone) polymer (sP), from 0.5 to 20% by weight of the non-sulfonated poly(arylene sulfone) polymer (P), from 3 to 20% by weight of the at least one pore forming additive (C) and from 40 to 96% by weight of the at least one solvent (D), based in each case on the total weight of the solution(S).

As the at least one solvent (D), any solvent known to the skilled person for the sulfonated poly(arylene ether sulfone) polymer (sP), the non-sulfonated poly(arylene sulfone) polymer (P) and the at least one pore forming additive (C) is suitable. Preferably, the at least one solvent (D) is soluble in water. Therefore, the at least one solvent (D) is preferably selected from the group consisting of N-alkyl-2-pyrrolidone, preferably N-methyl-2-pyrrolidone, N-ethyl-2-pyrrolidone, N-butyl-2-pyrrolidone and N-tert.-butyl-2-pyrrolidone, 2-pyrrolidone, N-dimethylacetamide, dimethylsulfoxide, dimethylformamide, N,N-dimethyl-2-hydroxypropan amide, N,N-diethyl-2-hydroxypropan amide, y-valerolactone, dihydrolevoglucosenone, methyl 5-(dimethylamino)-2-methyl-5-oxopentanoate and sulfolane. N-alkyl-2-pyrrolidone, y-valerolactone and N,N-dimethyl-2-hydroxypropan amide are particularly preferred. N-methylpyrrolidone is most preferred as the at least one solvent (D).

Another object of the present invention is therefore also a method for the preparation of a membrane (M), wherein the at least one solvent (D) is selected from the group consisting of N-alkyl-2-pyrrolidone, preferably N-methyl-2-pyrrolidone, N-ethyl-2-pyrrolidone, N-butyl-2-pyrrolidone and N-tert.-butyl-2-pyrrolidone, 2-pyrrolidone, N,N-dimethylacetamide, dimethylsulfoxide, dimethylformamide, N,N-dimethyl-2-hydroxypropan amide, N,N-diethyl-2-hydroxypropan amide, y-valerolactone, dihydrolevoglucosenone, methyl 5-(dimethylamino)-2-methyl-5-oxopentanoate and sulfolane.

The solution(S) can comprise, for example, in the range from 20 to 96% by weight of the at least one solvent (D), preferably in the range from 40 to 96% by weight of the at least one solvent (D), more preferably in the range from 50 to 70% by weight of the at least one solvent (D), based on the total weight of the solution(S).

The solution(S) provided in step a) furthermore comprises at least one pore forming additive (C) for the membrane preparation, wherein the at least one pore forming additive (C) comprises poly(vinyl pyrrolidone).

Further suitable pore forming additives (C) are poly(alkylene oxides) and alcohols.

Examples for suitable poly(alkylene oxides) are poly(ethylene oxide), poly(propylene oxide) and poly(ethylene oxide)-poly(propylene oxide) copolymer. Examples for suitable alcohols are divalent alcohols or trivalent alcohols like glycerol.

As further pore forming additive (C), alcohols, especially glycerol, are preferred.

Another object of the present invention is therefore also a method for the preparation of a membrane (M), wherein the at least one pore forming additive (C) also comprises at least one alcohol, preferably glycerol.

Preferably, the at least one pore forming additive (C) comprises in the range from 17 to 75% by weight of poly(vinyl pyrrolidone) and in the range from 25 to 83% by weight of at least one alcohol, preferably glycerol.

More preferably, the at least one pore forming additive (C) comprises in the range from 31.25 to 43.75% by weight of poly(vinyl pyrrolidone) and in the range from 56.25 to 68.75% by weight of at least one alcohol, preferably glycerol.

In a preferred embodiment, the at least one pore forming additive (C) consists of poly(vinyl pyrrolidone) and at least one alcohol, preferably glycerol.

The solution(S) can comprise the at least one pore forming additive (C), for example, in an amount of from 3 to 30% by weight, preferably of from 3 to 20% by weight, based on the total weight of the solution(S).

In a preferred embodiment, the solution(S) comprises from 3 to 15% by weight of poly(vinyl pyrrolidone) and from 5 to 15% by weight of at least one alcohol, based on the total weight of the solution(S).

In a more preferred embodiment, the solution(S) comprises from 5 to 7% by weight of poly(vinyl pyrrolidone) and from 9 to 11% by weight of at least one alcohol, based on the total weight of the solution(S).

To the person skilled in the art it is clear that the percentages by weight of the sulfonated poly(arylene ether sulfone) polymer (sP), the non-sulfonated poly(arylene sulfone) polymer (P), the at least one pore forming additive (C) and the at least one solvent (D) comprised in the solution(S) typically add up to 100% by weight.

The duration of step a) may vary between wide limits. The duration of step a) is preferably in the range from 10 min to 48 h (hours), especially in the range from 10 min to 24 h, and more preferably in the range from 15 min to 12 h. A person skilled in the art will choose the duration of step a) so as to obtain a homogeneous solution of the sulfonated poly(arylene ether sulfone) polymer (sP), the non-sulfonated poly(arylene sulfone) polymer (P) and the at least one pore forming additive (C) in the at least one solvent (D).

### Step b)

In step b), the at least one pore forming additive (C) and the at least one solvent (D) are separated from the solution(S) to obtain the membrane (M).

It is possible to filter the solution(S) provided in step a) before the at least one pore forming additive (C) and the at least one solvent (D) are separated from the solution(S) in step b) to obtain a filtered solution (fS). The following embodiments and preferences for separating the at least one pore forming additive (C) and the at least one solvent (D) from the solution(S) apply equally for separating the at least one pore forming additive (C) and the at least one solvent (D) from the filtered solution (fS).

Moreover, it is possible to degas the solution(S) in step a) before the at least one pore forming additive (C) and the at least one solvent (D) are separated from the solution(S) in step b) to obtain a degassed solution (dS). This embodiment is preferred. The following embodiments and preferences for separating the at least one pore forming additive (C) and the at least one solvent (D) from the solution(S) apply equally for separating the at least one pore forming additive (C) and the at least one solvent (D) from the degassed solution (dS).

The degassing of the solution(S) in step a) can be carried out by any method known to the skilled person, for example, via vacuum or by allowing the solution(S) to rest.

The separation of the at least one pore forming additive (C) and the at least one solvent (D) from the solution(S) can be performed by any method known to the skilled person which is suitable to separate pore forming additives and solvents from polymers.

Preferably, the separation of the at least one pore forming additive (C) and the at least one solvent (D) from the solution(S) is carried out via a phase inversion process.

Another object of the present invention is therefore also a method for the preparation of a membrane (M), wherein the separation of the at least one pore forming additive (C) and the at least one solvent (D) in step b) is carried out via a phase inversion process.

If the separation of the at least one pore forming additive (C) and the at least one solvent (D) is carried out via a phase inversion process, the obtained membrane (M) is typically a porous membrane.

Therefore, another object of the present invention is a membrane (M), wherein the membrane (M) is a porous membrane (M).

As a person skilled in the art knows, the porous membrane (M) typically has a top layer and a supporting structure at the bottom, wherein the top layer is the active filtration layer. The top layer, as well as, the supporting structure typically comprise pores, wherein the pore size distribution of the top layer is actually the only decisive factor for the properties of the membrane. In general, the pore size of the top layer is smaller than the pore size of the supporting structure at the bottom.

Preferably, the pore size of the membrane (M) increases from the top layer, which is used for separation, to the bottom of the membrane (M). Therefore, such a membrane (M) is also called an asymmetric membrane (M).

A further object of the present invention is therefore a membrane (M), wherein the membrane (M) is asymmetric.

The minimal pore diameter of the membrane (M) is preferably <10 nm.

The supporting structure can have diameters up to 10 μm.

A phase inversion process within the context of the present invention means a process wherein the dissolved sulfonated poly(arylene ether sulfone) polymer (sP) and the dissolved non-sulfonated poly(arylene sulfone) polymer (P) are transformed into a solid phase. Therefore, a phase inversion process can also be denoted as precipitation process. According to step b), the transformation is performed by separation of the at least one pore forming additive (C) and the at least one solvent (D) from the sulfonated poly(arylene ether sulfone) polymer (sP) and the non-sulfonated poly(arylene sulfone) polymer (P). The person skilled in the art knows suitable phase inversion processes.

The phase inversion process can, for example, be performed by cooling down the solution(S). During this cooling down, the sulfonated poly(arylene ether sulfone) polymer (sP) and the non-sulfonated poly(arylene sulfone) polymer (P) comprised in the solution(S) precipitate. Another possibility to perform the phase inversion process is to bring the solution(S) in contact with a vapour that is a non-solvent for the sulfonated poly(arylene ether sulfone) polymer (sP) and the non-sulfonated poly(arylene sulfone) polymer (P). The sulfonated poly(arylene ether sulfone) polymer (sP) and the non-sulfonated poly(arylene sulfone) polymer (P) will then as well precipitate. Suitable vapours, that are non-solvents for the sulfonated poly(arylene ether sulfone) polymer (sP) and the non-sulfonated poly(arylene sulfone) polymer (P), are, for example, protic polar solvents described hereinafter in their gaseous state. Another phase inversion process, which is preferred within the context of the present invention, is the phase inversion by immersing the solution(S) into at least one protic polar solvent.

Therefore, in one embodiment of the present invention, in step b), the at least one pore forming additive (C) and the at least one solvent (D) comprised in the solution(S) are separated from the sulfonated poly(arylene ether sulfone) polymer (sP) and the non-sulfonated poly(arylene sulfone) polymer (P) comprised in the solution(S) by immersing the solution(S) into at least one protic polar solvent.

This means that the membrane (M) is formed by immersing the solution(S) into at least one protic polar solvent.

Suitable at least one protic polar solvents are known to the skilled person. The at least one protic polar solvent is preferably a non-solvent for the sulfonated poly(arylene ether sulfone) polymer (sP) and the non-sulfonated poly(arylene sulfone) polymer (P).

Preferred at least one protic polar solvents are water, methanol, ethanol, n-propanol, iso-propanol, glycerol, ethyleneglycol and mixtures thereof. Preferably, the at least one protic polar solvent is a water-based coagulation bath.

Therefore, another object of the present invention is a method for the preparation of a membrane (M), wherein the at least one protic polar solvent is a water-based coagulation bath.

Preferably, the water-based coagulation bath beside water also comprises further components, for example, the same solvent (D) as comprised in the solution(S) or an alcohol, especially glycerol.

Step b) usually comprises a provision of the solution(S) in a form that corresponds to the form of the membrane (M), which is obtained in step b).

Therefore, in one embodiment of the present invention, step b) comprises a casting of the solution(S) to obtain a film of the solution(S).

Therefore, in one preferred embodiment of the present invention, step b) comprises the following steps:
b-1) casting the solution(S) provided in step a) to obtain a film of the solution(S),
b-2) immersing the film of the solution(S) into at least one protic polar solvent, wherein the sulfonated poly(arylene ether sulfone) polymer (sP) and the non-sulfonated poly(arylene sulfone) polymer (P) comprised in the film of the solution(S) are at least partly separated from the at least one pore forming additive (C) and the at least one solvent (D) comprised in the film of the solution(S) to obtain a membrane (M1) which is in the form of a film, and
b-3) washing the membrane (M1) with water, wherein the sulfonated poly(arylene ether sulfone) polymer (sP) and the non-sulfonated poly(arylene sulfone) polymer (P) comprised in the membrane (M1) are essentially completely separated from the at least one pore forming additive (C) and the at least one solvent (D) comprised in the membrane (M1) to obtain the membrane (M).

Therefore, another object of the present invention is a method for the preparation of a membrane (M), wherein step b) comprises the following steps:
b-1) casting the solution(S) provided in step a) to obtain a film of the solution(S),
b-2) immersing the film of the solution(S) into at least one protic polar solvent, wherein the sulfonated poly(arylene ether sulfone) polymer (sP) and the non-sulfonated poly(arylene sulfone) polymer (P) comprised in the film of the solution(S) are at least partly separated from the at least one pore forming additive (C) and the at least one solvent (D) comprised in the film of the solution(S) to obtain a membrane (M1) which is in the form of a film, and
b-3) washing the membrane (M1) with water, wherein the sulfonated poly(arylene ether sulfone) polymer (sP) and the non-sulfonated poly(arylene sulfone) polymer (P) comprised in the membrane (M1) are essentially completely separated from the at least one pore forming additive (C) and the at least one solvent (D) comprised in the membrane (M1) to obtain the membrane (M).

The term “at least partly” within the context of the present invention means that preferably at least 50% by weight, more preferably at least 60% by weight, of the sulfonated poly(arylene ether sulfone) polymer (SP) and the non-sulfonated poly(arylene sulfone) polymer (P), based on the total weight of the sulfonated poly(arylene ether sulfone) polymer (sP) and the non-sulfonated poly(arylene sulfone) polymer (P) comprised in the film of the solution(S), are separated from the at least one pore forming additive (C) and the at least one solvent (D).

The term “essentially completely” within the context of the present invention means that preferably at least 90% by weight, more preferably at least 95% by weight, of the sulfonated poly(arylene ether sulfone) polymer (sP) and the non-sulfonated poly(arylene sulfone) polymer (P), based on the total weight of the sulfonated poly(arylene ether sulfone) polymer (sP) and the non-sulfonated poly(arylene sulfone) polymer (P) comprised in the membrane (M1), are separated from the at least one pore forming additive (C) and the at least one solvent (D).

In a preferred embodiment, the membrane (M) exhibits increased poly(vinyl pyrrolidone) (PVP) contents (PVPₜₒₜₐₗ and PVP_{surface}) which means that the inventive membrane (M) withholds poly(vinyl pyrrolidone) in the membrane matrix, and, therefore, prevents the leaching out of poly(vinyl pyrrolidone) off the membrane matrix.

Preferably, the membrane (M) has a poly(vinyl pyrrolidone) content PVPₜₒₜₐₗ in the range from 0.8 to 5% by weight, based on the total weight of the membrane (M).

In step b-1) the solution(S) can be cast by any method known to the skilled person. Usually, the solution(S) is cast with a casting knife that is heated to a temperature in the range from 20 to 100° C., preferably in the range from 40 to 80° C.

Therefore, another object of the present invention is a method for the preparation of a membrane (M), wherein step b-1) is carried out at a temperature in the range of 40 to 80° C.

The solution(S) is usually cast on a substrate that does not react with the sulfonated poly(arylene ether sulfone) polymer (sP), the non-sulfonated poly(arylene sulfone) polymer (P), the at least one pore forming additive (C) or the at least one solvent (D) comprised in the solution(S).

Suitable substrates are known to the skilled person and are, for example, selected from glass plates, polymer films and polymer fabrics such as non-woven materials.

In step b-2), the film of the solution(S) is preferably immersed into at least one protic polar solvent at a temperature in the range of 20 to 80° C., more preferably at a temperature in the range of 20 to 60° C.

In step b-3), the membrane (M1) is preferably washed at a temperature in the range of to 80° C., more preferably at a temperature in the range of 20 to 60° C.

The membrane (M) obtained in step b-3) is preferably a flat sheet membrane.

The membrane (M) can be used as ultrafiltration and/or haemodialysis membrane.

A further object of the present invention is therefore also the use of the membrane (M) as ultrafiltration membrane and/or for haemodialysis applications.

To obtain a dense membrane, the separation in step b) can be carried out by evaporation of the at least one solvent (D) comprised in the solution(S).

For the production of single bore hollow fibers, step b) may be performed by extruding the solution(S) through an extrusion nozzle with the required number of hollow needles. The coagulating liquid is then injected through the hollow needles into the extruded polymer during extrusion, so that parallel continuous channels extending in extrusion direction are formed in the extruded polymer. Preferably, the pore size on an outer surface of the extruded membrane is controlled by bringing the outer surface after leaving the extrusion nozzle in contact with a mild coagulation agent such that the shape is fixed without active layer on the outer surface and subsequently the membrane is brought into contact with a strong coagulation agent.

### Membrane (M)

A further object of the present invention is also the membrane prepared by the inventive method described above.

The membrane (M) comprises a sulfonated poly(arylene ether sulfone) polymer (sP) and a non-sulfonated poly(arylene sulfone) polymer (P).

Preferably, the membrane (M) comprises from 5 to 90% by weight, more preferably from 7.5 to 80% by weight, of the sulfonated poly(arylene ether sulfone) polymer (sP), based on the total weight of the membrane (M).

A further object of the present invention is therefore a membrane (M), wherein the membrane (M) comprises from 5 to 90% by weight of the sulfonated poly(arylene ether sulfone) polymer (sP), based on the total weight of the membrane (M).

The membrane (M) also preferably comprises from 10 to 95% by weight, more preferably from 20 to 92.5% by weight, of the non-sulfonated poly(arylene sulfone) polymer (P), based on the total weight of the membrane (M).

Therefore, in a preferred embodiment, the membrane (M) comprises from 5 to 90% by weight of the sulfonated poly(arylene ether sulfone) polymer (sP) and from 10 to 95% by weight of the non-sulfonated poly(arylene sulfone) polymer (P), based in each case on the total weight of the membrane (M).

The membrane (M) preferably has a pure water permeation of >50 kg/(h m² bar), determined using a pressure cell with a diameter of 74 mm using ultrapure water (salt-free water, filtered by a Millipore UF-system) at 23° C. and 1 bar water pressure. The pure water permeation (PWP) is calculated as follows (equation (1)):

$$PWP = \frac{m}{A \times P \times t} \qquad ( 1 )$$

PWP: pure water permeation [kg/bar h m²]
m: mass of permeated water [kg]
A: membrane area [m²]
P: pressure [bar]
t: time of the permeation experiment [h].

A further object of the present invention is therefore a membrane (M), wherein the membrane (M) has a pure water permeation of >50 kg/h m² bar.

In a preferred embodiment, the membrane (M) has a molecular weight cut-off in the range from 10 to 30 kDa.

A further object of the present invention is therefore a membrane (M), wherein the membrane (M) has a molecular weight cut-off in the range from 10 to 30 kDa.

### Component (A)

The solution(S) comprises as component (A) a sulfonated poly(arylene ether sulfone) polymer (sP). In the present case the terms “a sulfonated poly(arylene ether sulfone) polymer (sP)” and “component (A)” are used synonymously and therefore have the same meaning.

The term “a sulfonated poly(arylene ether sulfone) polymer (sP)” in the present case, is understood to mean exactly one sulfonated poly(arylene ether sulfone) polymer (sP) and also mixtures of two or more sulfonated poly(arylene ether sulfone) polymers (sP).

In a preferred embodiment, the sulfonated poly(arylene ether sulfone) polymer (sP) comprises units of formula (I)

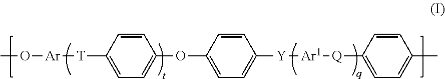

where
t and q: are each independently 0, 1, 2 or 3,
Q, T and Y: are each independently a chemical bond or a group selected from —O—, —S—, —SO₂—, —S(═O)—, —(C═O)—, —N═N— and —CR^{a}R^{b}—,
   wherein R^{a} and R^{b} are each independently a hydrogen atom or a C₁-C₁₂ alkyl, C₁-C₁₂ alkoxy or C₆-C₁₈ aryl group, and where at least one of Q, T and Y is —SO₂— and
Ar and Ar¹: are each independently an arylene group having from 6 to 18 carbon atoms
and where
at least one unit (I) comprises an arylene group which is substituted with at least one-SO₂X group, wherein X is selected from the group consisting of Cl and O⁻ combined with one cation equivalent, where the cation equivalent is H⁺, Li⁺, Na⁺, K⁺, Mg²⁺, Ca²⁺ or NH₄⁺.

Another object of the present invention is therefore a method, wherein the sulfonated poly(arylene ether sulfone) polymer (sP) comprises units of formula (I)

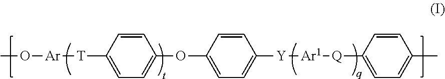

where
t and q: are each independently 0, 1, 2 or 3,
Q, T and Y: are each independently a chemical bond or a group selected from —O—, —S—, —SO₂—, —S(═O)—, —(C═O)—, —N═N— and —CR^{a}R^{b}—,
   wherein R^{a} and R^{b} are each independently a hydrogen atom or a C₁-C₁₂ alkyl, C₁-C₁₂ alkoxy or C₆-C₁₈ aryl group, and where at least one of Q, T and Y is —SO₂— and
Ar and Ar¹: are each independently an arylene group having from 6 to 18 carbon atoms
and where
at least one unit (I) comprises an arylene group which is substituted with at least one-SO₂X group, wherein X is selected from the group consisting of Cl and O⁻ combined with one cation equivalent, where the cation equivalent is H⁺, Li⁺, Na⁺, K⁺, Mg²⁺, Ca²⁺ or NH₄⁺.

If Q, T or Y, among the abovementioned conditions, is a chemical bond, this is understood to mean that the adjacent group to the left and the adjacent group to the right are bonded directly to one another via a chemical bond. It will be readily appreciated that at least one of the groups consisting of Q, T and Y being —SO₂— means that at least one of Q, T and Y in formula (I) is —SO₂—. The consequence is, for example, that when q is =0, at least one of T and Y is —SO₂—; when, for example, t is =0, at least one of Q and Y is —SO₂— and when q=0 and t=0 then Y is SO₂.

If Q, T or Y is —CR^{a}R^{b}—, R^{a} and R^{b} are each independently a hydrogen atom or a C₁-C₁₂-alkyl, C₁-C₁₂-alkoxy or C₆-C₁₈-aryl group.

Preferred C₁-C₁₂-alkyl groups comprise linear and branched, saturated alkyl groups having from 1 to 12 carbon atoms. Particular mention should be made of the following radicals: C₁-C₆-alkyl radical such as methyl, ethyl, n-propyl, i-propyl, n-butyl, sec-butyl, 2- or 3-methylpentyl and longer-chain radicals such as unbranched heptyl, octyl, nonyl, decyl, undecyl, lauryl and the singly or multiply branched analogs thereof.

Useful alkyl radicals in the aforementioned usable C₁-C₁₂-alkoxy groups include the alkyl groups having from 1 to 12 carbon atoms defined above. Cycloalkyl radicals usable with preference comprise especially C₃-C₁₂-cycloalkyl radicals, for example cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl,-propyl,-butyl,-pentyl,-hexyl, cyclohexylmethyl,-dimethyl, and -trimethyl.

Ar and Ar¹ are each independently a C₆-C₁₈-arylene group. Proceeding from the starting materials described below, Ar is preferably derived from an electron-rich aromatic substance subject to easy electrophilic attack, preferably selected from the group consisting of hydroquinone, resorcinol, dihydroxynaphthalene, especially 2,7-dihydroxynaphthalene, and 4,4′-bisphenol. Preferably, Ar¹ is an unsubstituted C₆- or C₁₂-arylene group.

Useful C₆-C₁₈-arylene groups Ar and Ar¹ especially include phenylene groups such as 1,2-, 1,3- and 1,4-phenylene, naphthylene groups, for example 1,6-, 1,7-, 2,6- and 2,7-naphthylene, and the arylene groups derived from anthracene, phenanthrene and naphthacene.

Preferably, Ar and Ar¹ in the preferred embodiment of formula (I) are each independently selected from the group consisting of 1,4-phenylene, 1,3-phenylene, naphthylene, especially 2,7-dihydroxynaphthylene, and 4,4′-bisphenylene.

Preferred sulfonated poly(arylene ether sulfone) polymers (sP) are those comprising at least one of the following units Ia to Io as repeat structural units, wherein at least one unit (I) comprises an arylene group which is substituted with at least one —SO₂X group, wherein X is selected from the group consisting of Cl and O⁻ combined with one cation equivalent, where the cation equivalent is H⁺, Li⁺, Na⁺, K⁺, Mg²⁺, Ca²⁺ or NH₄⁺:

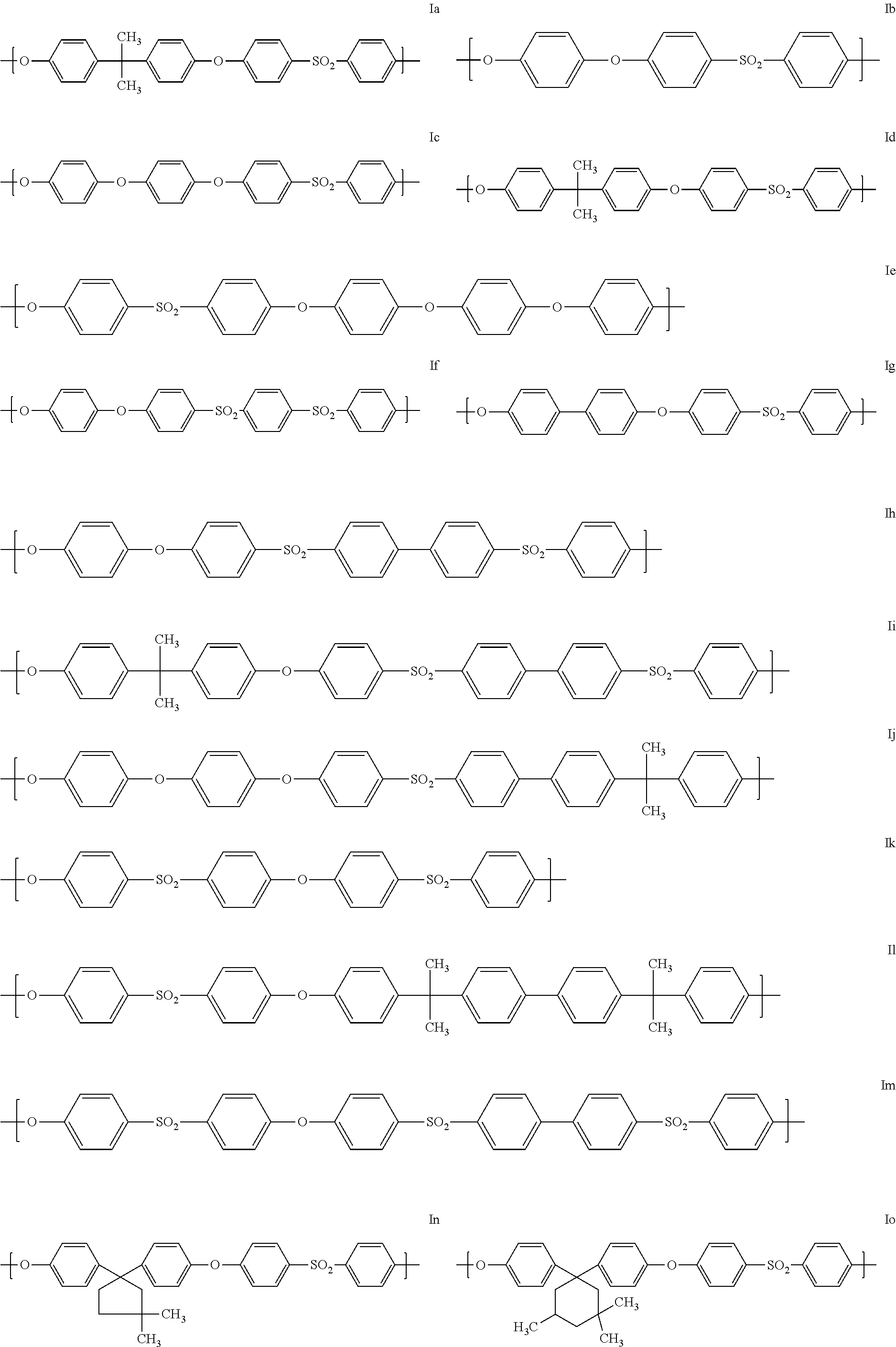

In addition to the preferred units Ia to Io, preference is also given to those units in which one or more 1,4-phenylene units which originate from hydroquinone are replaced by 1,3-phenylene units which originate from resorcinol or by naphthylene units which originate from dihydroxynaphthalene.

Particularly preferred units of the general formula (I) are the units Ia, Ig and Ik. It is also particularly preferred when the sulfonated poly(arylene ether sulfone) polymers of component (A) are formed essentially from one kind of units of the general formula (I), especially from a unit selected from Ia, Ig and Ik.

In a particularly preferred embodiment, Ar=1,4-phenylene, t=1, q=0, T is a chemical bond and Y═SO₂. Particularly preferred sulfonated poly(arylene ether sulfone) polymers (A) formed from the aforementioned repeat unit are referred to as sulfonated polyphenylene sulfone (PPSU) (formula Ig).

In a further particularly preferred embodiment, Ar=1,4-phenylene, t=1, q=0, T=C(CH₃)₂ and Y=SO₂. Particularly preferred sulfonated poly(arylene ether sulfone) polymers (A) formed from the aforementioned repeat unit are referred to as sulfonated polysulfone (PSU) (formula Ia).

In a further particularly preferred embodiment, Ar=1,4-phenylene, t=1, q=0, T=Y=SO₂. Particularly preferred sulfonated poly(arylene ether sulfone) polymers (A) formed from the aforementioned repeat unit are referred to as sulfonated poly(ether sulfone) (PESU) (formula Ik).

Abbreviations such as PPSU, PESU and PSU in the context of the present invention conform to DIN EN ISO 1043-1 (Plastics-Symbols and abbreviated terms-Part 1: Basic polymers and their special characteristics (ISO 1043-1:2001); German version EN ISO 1043-1:2002).

In a preferred embodiment, the sulfonated poly(arylene ether sulfone) polymer (sP) according to component (A) is a copolymer formed from poly(ether sulfone) (PESU) units and poly(phenylene sulfone) (PPSU) units, wherein at least one unit comprises an arylene group which is substituted with at least one —SO₂X group, wherein X is selected from the group consisting of Cl and O⁻ combined with one cation equivalent, where the cation equivalent is H⁺, Li⁺, Na⁺, K⁺, Mg²⁺, Ca²⁺ or NH₄⁺. This copolymer may, for example, be a random copolymer or a block copolymer. Preference is given to a random copolymer formed from poly(ether sulfone) (PESU) and poly(phenylene sulfone) (PPSU) for the reason that a more homogenous material is obtained which shows no or little phase separation in the dissolved or solid state.

In case the sulfonated poly(arylene ether sulfone) polymer (sP) according to component (A) is a copolymer formed from poly(ether sulfone) (PESU) units and poly(phenylene sulfone) (PPSU) units, the sulfonated poly(arylene ether sulfone) polymer (sP) comprises in the range from 1 to 20 mol % of poly(phenylene sulfone) (PPSU) units and from 80 to 99 mol % of poly(ether sulfone) (PESU) units, in each case based on the total sum of all repeating units of component (A).

In a particularly preferred embodiment, the sulfonated poly(arylene ether sulfone) polymer (sP) comprises units of formula (III)

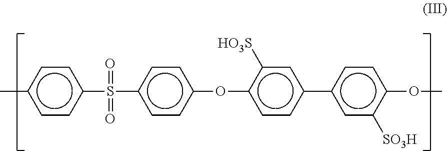

and/or formula (IV)

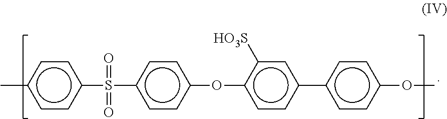

A further object of the present invention is therefore a method, wherein the sulfonated poly(arylene ether sulfone) polymer (sP) comprises units of formula (III)

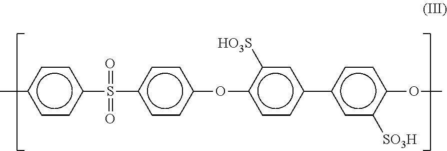

and/or formula (IV)

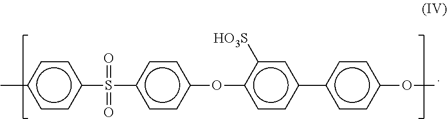

In a preferred embodiment the sulfonated poly(arylene ether sulfone) polymer (sP) comprises units of formula (V)

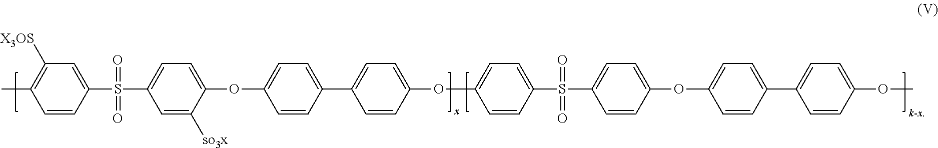

i) has a number-average molecular weight (MN) of from 10 000 to 35 000 g/mol, and/or
ii) comprises an arylene group which is substituted with at least one —SO₃X group, wherein X is selected from the group of cation equivalents of H⁺, Li⁺, Na⁺, K⁺, Mg²⁺, Ca²⁺ or NH₄⁺
iii) x is in the range of 0.01 to 1, preferably in the range of 0.02 to 0.5, more preferred in the range of 0.04 to 0.4 and x+k is 1.

The sum of “x” and “k” equals 1.

In a further particularly preferred embodiment, the sulfonated poly(arylene ether sulfone) polymer (sP) comprises units of formula (V)

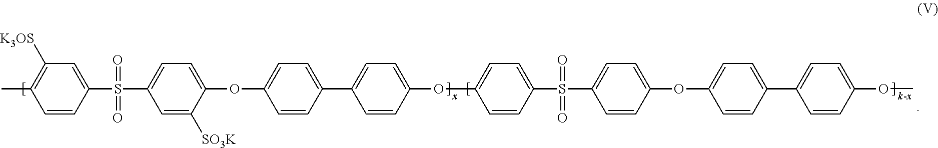

A further object of the present invention is therefore a method, wherein the sulfonated poly(arylene ether sulfone) polymer (sP) comprises units of formula (V)

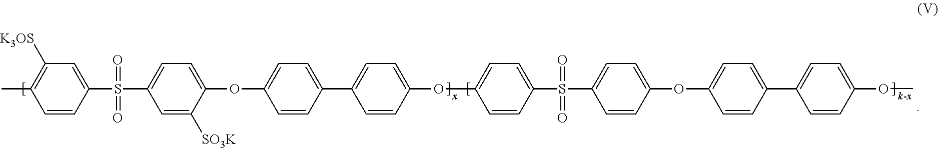

It is also possible that the sulfonated poly(arylene ether sulfone) polymer (sP) comprises units of formula (III) and/or formula (IV) and/or formula (V).

The sulfonated poly(arylene ether sulfone) polymer (sP) preferably has a number-average molecular weight (M_{N}) of from 10 000 to 35 000 g/mol, determined by gel permeation chromatography in dimethylacetamide as solvent versus narrowly distributed polymethyl methacrylate as standard.

A further object of the present invention is therefore a method, wherein the sulfonated poly(arylene ether sulfone) polymer (sP) has a number-average molecular weight (M_{N}) of from 10 000 to 35 000 g/mol.

In addition, the sulfonated poly(arylene ether sulfone) polymer (sP) preferably has a content of free acid of less than 3 mg KOH/g sulfonated poly(arylene ether sulfone) polymer (sP), determined by titration with 0.1 mol/l tetrabutylammoniumhydroxide solution (TBAH, in methanol/toluene) against a Solvotrode30 electrode (Metrohm).

A further object of the present invention is therefore a method, wherein the sulfonated poly(arylene ether sulfone) polymer (sP) has a content of free acid of less than 3 mg KOH/g sulfonated poly(arylene ether sulfone) polymer (sP).

The sulfonated poly(arylene ether sulfone) polymer (SP) can be prepared by any method known to the person skilled in the art.

Preferably, the sulfonated poly(arylene ether sulfone) polymer (sP) is produced by treating a non-sulfonated poly(arylene ether sulfone) polymer with at least one sulfonating agent. The at least one sulfonating agent is suitably any compound known to a person skilled in the art that is capable of introducing at least one SO₂X group, where X is Cl or O⁻, combined with one cation equivalent, where the cation equivalent is H⁺, Li⁺, Na⁺, K⁺, Mg²⁺, Ca²⁺ or NH₄⁺, into an aromatic ring of the non-sulfonated poly(arylene ether sulfone) polymer. The SO₂X group is preferably a sulfonic acid group (—SO₃H) or a group capable of reacting with water to form a sulfonic acid group. Groups of this type are known to a person skilled in the art and include, for example, chlorosulfonyl groups (—SO₂Cl). The SO₂X group is more preferably therefore a sulfonic acid group (—SO₃H) or a chlorosulfonyl group (—SO₂Cl), most preferably the SO₂X group is a sulfonic acid group (—SO₃H).

The reaction of the non-sulfonated poly(arylene ether sulfone) polymer with the at least one sulfonating agent preferably sulfonates at least one of the aromatic rings of the non-sulfonated poly(arylene ether sulfone) polymer at least partially.

The mechanism of the sulfonation reaction is known as such to a person skilled in the art. Thereby it is particularly preferable for the sulfonation reaction to replace a hydrogen atom of the aromatic ring by a sulfonic acid group (—SO₃H).

Typically, from 0.001 to 1, preferably from 0.005 to 0.1 and more preferably from 0.01 to 0.08 SO₂X groups per aromatic ring is introduced into the non-sulfonated poly(arylene ether sulfone) polymer. The sulfonated poly(arylene ether sulfone) polymer (sP) therefore typically has from 0.001 to 1, preferably from 0.005 to 0.1, and more preferably from 0.01 to 0.08 sulfonic acid groups per aromatic ring.

The number of SO₂X groups per aromatic ring is determined by averaging over all the aromatic rings of the sulfonated poly(arylene ether sulfone) polymer (sP). To this end, the number of SO₂X groups in the sulfonated poly(arylene ether sulfone) polymer (sP) is divided by the number of aromatic rings in the sulfonated poly(arylene ether sulfone) polymer (sP). Methods of determining the number of SO₂X groups and the number of aromatic rings, each in the sulfonated poly(arylene ether sulfone) polymer (sP), are known to a person skilled in the art. The number of SO₂X groups is determinable, for example, by acid-base titration or by spectroscopic methods such as H¹NMR spectroscopy or IR spectroscopy (infrared spectroscopy). Sulfonated aromatic polymers having SO₂X groups on the aromatic ring display characteristic peaks and bands, making it possible to determine the number of SO₂X groups per aromatic ring in the sulfonated poly(arylene ether sulfone) polymer (sP). The ratio of sulfonated to non-sulfonated aromatic rings can also be determined by these methods, in particular by H¹NMR spectroscopy.

When the non-sulfonated poly(arylene ether sulfone) polymer has aromatic rings which differ in their degrees of substitution it is thus typically the case that the strongest nucleophilic aromatic rings are preferentially sulfonated.

### Component (B)

The solution(S) comprises as component (B) a non-sulfonated poly(arylene sulfone) polymer (P). In the present case the terms “a non-sulfonated poly(arylene sulfone) polymer (P)” and “component (B)” are used synonymously and therefore have the same meaning.

The term “a non-sulfonated poly(arylene sulfone) polymer (P)” in the present case, is understood to mean exactly one non-sulfonated poly(arylene sulfone) polymer (P) and also mixtures of two or more non-sulfonated poly(arylene sulfone) polymers (P).

“Non-sulfonated” within the context of the present invention means that the non-sulfonated poly(arylene sulfone) polymer (P) does not comprise any —SO₂X group, wherein X is selected from the group consisting of Cl and O⁻ combined with one cation equivalent.

“One cation equivalent” within the context of the present invention means one cation of a single positive charge or one charge equivalent of a cation with two or more positive charges, for example, H⁺, Li⁺, Na⁺, K⁺, Mg²⁺, Ca²⁺ or NH₄⁺.

Preferably, the non-sulfonated poly(arylene sulfone) polymer (P) comprises units of formula (II)

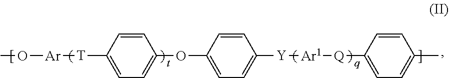

where
t and q: are each independently 0, 1, 2 or 3,
Q, T and Y: are each independently a chemical bond or a group selected from —O—, —S—, —SO₂—, —(S═O)—, —(C═O)—, —N═N— and —CR^{a}R^{b}—
   wherein R^{a} and R^{b} are each independently a hydrogen atom or a C₁-C₁₂-alkyl, C₁-C₁₂-alkoxy or C₆-C₁₈-aryl group, and where at least one of Q, T and Y is —SO₂— and
Ar, Ar¹: are each independently an arylene group having from 6 to 18 carbon atoms.

A further object of the present invention is therefore a method, wherein the non-sulfonated poly(arylene sulfone) polymer (P) comprises units of formula (II)

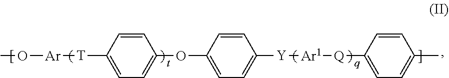

where
t and q: are each independently 0, 1, 2 or 3,
Q, T and Y: are each independently a chemical bond or a group selected from —O—, —S—, —SO₂—, —(S═O)—, —(C═O)—, —N═N— and —CR^{a}R^{b}—
   wherein R^{a} and R^{b} are each independently a hydrogen atom or a C₁-C₁₂-alkyl, C₁-C₁₂-alkoxy or C₆-C₁₈-aryl group, and where at least one of Q, T and Y is —SO₂— and
Ar, Ar¹: are each independently an arylene group having from 6 to 18 carbon atoms.

If Q, T or Y, among the abovementioned conditions, is a chemical bond, this is understood to mean that the adjacent group to the left and the adjacent group to the right are bonded directly to one another via a chemical bond. Preferably, however, Q, T and Y in formula (II) are each independently selected from —O— and —SO₂—, with the proviso that at least one of the group consisting of Q, T and Y is —SO₂—.

If Q, T or Y is —CR^{a}R^{b}—, R^{a} and R^{b} are each independently a hydrogen atom or a C₁-C₁₂-alkyl, C₁-C₁₂-alkoxy or C₆-C₁₈-aryl group.

Preferred C₁-C₁₂-alkyl groups comprise linear and branched, saturated alkyl groups having from 1 to 12 carbon atoms. Particular mention should be made of the following radicals: C₁-C₆-alkyl radical such as methyl, ethyl, n-propyl, i-propyl, n-butyl, sec-butyl, 2- or 3-methylpentyl and longer-chain radicals such as unbranched heptyl, octyl, nonyl, decyl, undecyl, lauryl and the singly or multiply branched analogs thereof.

Useful alkyl radicals in the aforementioned usable C₁-C₁₂-alkoxy groups include the alkyl groups having from 1 to 12 carbon atoms defined above. Cycloalkyl radicals usable with preference comprise especially C₃-C₁₂-cycloalkyl radicals, for example cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl,-propyl,-butyl,-pentyl,-hexyl, cyclohexylmethyl,-dimethyl, and -trimethyl.

Ar and Ar¹ are each independently a C₆-C₁₈-arylene group. Proceeding from the starting materials described below, Ar is preferably derived from an electron-rich aromatic substance subject to easy electrophilic attack, preferably selected from the group consisting of hydroquinone, resorcinol, dihydroxynaphthalene, especially 2,7-dihydroxynaphthalene, and 4,4′-bisphenol. Preferably, Ar¹ is an unsubstituted C₆- or C₁₂-arylene group.

Useful C₆-C₁₈-arylene groups Ar and Ar¹ especially include phenylene groups such as 1,2-, 1,3- and 1,4-phenylene, naphthylene groups, for example 1,6-, 1,7-, 2,6- and 2,7-naphthylene, and the arylene groups derived from anthracene, phenanthrene and naphthacene.

Preferably, Ar and Ar¹ in the preferred embodiment of formula (II) are each independently selected from the group consisting of 1,4-phenylene, 1,3-phenylene, naphthylene, especially 2,7-dihydroxynaphthylene, and 4,4′-bisphenylene.

Preferred non-sulfonated poly(arylene sulfone) polymers (P) are those comprising at least one of the units Ia to Io as defined above as repeat structural units.

In addition to the preferred units Ia to Io, preference is also given to those units in which one or more 1,4-phenylene units which originate from hydroquinone are replaced by 1,3-phenylene units which originate from resorcinol or by naphthylene units which originate from dihydroxynaphthalene.

Particularly preferred units of the general formula (II) are the units Ia, Ig and Ik. It is also particularly preferred when the non-sulfonated poly(arylene sulfone) polymers (P) of component (B) are formed essentially from one kind of units of the general formula (II), especially from a unit selected from Ia, Ig and Ik.

In a particularly preferred embodiment, Ar=1,4-phenylene, t=1, q=0, T is a chemical bond and Y═SO₂. Particularly preferred non-sulfonated poly(arylene sulfone) polymers (B) formed from the aforementioned repeat unit are referred to as poly(phenylene sulfone) (PPSU) (formula Ig).

In a further particularly preferred embodiment, Ar=1,4-phenylene, t=1, q=0, T=C(CH₃)₂ and Y=SO₂. Particularly preferred non-sulfonated poly(arylene sulfone) polymers (B) formed from the aforementioned repeat unit are referred to as polysulfone (PSU) (formula Ia).

In a further particularly preferred embodiment, Ar=1,4-phenylene, t=1, q=0, T=Y=SO₂. Particularly preferred non-sulfonated poly(arylene sulfone) polymers (B) formed from the aforementioned repeat unit are referred to as poly(ether sulfone) (PESU) (formula Ik).

Therefore, another object of the present invention is a method, wherein the non-sulfonated poly(arylene sulfone) polymer (P) is
i) a poly(ether sulfone) and comprises units of formula (Ik)

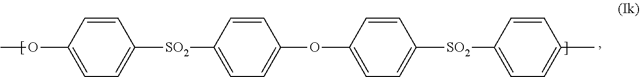

or
ii) a polysulfone and comprises units of formula (Ia)

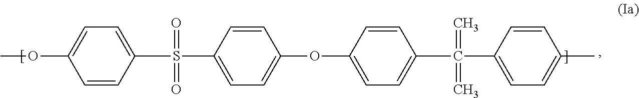

or
iii) a polyphenylene sulfone and comprises units of formula (Ig)

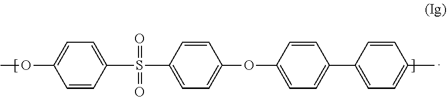

The non-sulfonated poly(arylene ether sulfone) polymers preferably have weight-average molecular weights M_{w} of 10 000 to 150 000 g/mol, especially of 15 000 to 120 000 g/mol, more preferably of 18 000 to 100 000 g/mol, determined by means of gel permeation chromatography in a dimethylacetamide solvent against narrow-distribution polymethylmethacrylate as standard.

Preparation processes which lead to the aforementioned non-sulfonated poly(arylene sulfone) polymers are known per se to those skilled in the art and are described, for example, in Herman F. Mark, “Encyclopedia of Polymer Science and Technology”, third edition, Volume 4, 2003, “Polysulfones” chapter on pages 2 to 8, and in Hans R. Kricheldorf, “Aromatic Polyethers” in: Handbook of Polymer Synthesis, second edition, 2005, on pages 427 to 443.

Particular preference is given to the reaction of at least one aromatic compound having two halogen substituents and at least one aromatic compound having two functional groups reactive toward the aforementioned halogen substituents in aprotic polar solvents in the presence of anhydrous alkali metal carbonate, especially sodium, potassium or calcium carbonate or mixtures thereof, very particular preference being given to potassium carbonate. A particularly suitable combination is N-methyl-2-pyrrolidone as solvent and potassium carbonate as base.

The present invention is more particularly elucidated by the following examples without being restricted thereto.

### EXAMPLES

### Components Used

### Sulfonated Poly(Arylene Ether Sulfone) Polymers:

### Synthesis of the Sulfonated Polyethersulfone-Polyphenylenesulfone Copolymer: sP1 (Component (A1)):

### 1) Synthesis of the Polyethersulfone-Polyphenylenesulfone Copolymer

In a 4 liter glass reactor fitted with a thermometer, a gas inlet tube and a Dean-Stark-trap, 574.34 g (2.0 mol) of 4,4′-dichlorodiphenylsulfone (DCDPS), 475.53 g (1.90 mol) of 4,4′-dihydroxydiphenylsulfone (DHDPS), 18.621 g (0.10 mol) of 4,4′-biphenol and 297.15 g (2.15 mol) of potassium carbonate with a volume average particle size of 33.2 μm are suspended in 1050 mL NMP (N-methyl-2-pyrrolidone; CAS 872-50-4) in a nitrogen atmosphere. The mixture is heated to 190° C. within one hour. In the following, the reaction time shall be understood to be the time during which the reaction mixture is maintained at 190° C. The water formed in the reaction is continuously removed by distillation. The evaporated solvent is replaced. After a reaction time of 7 hours, the reaction is stopped by the addition of 1 950 mL NMP and cooled down to room temperature (within one hour). The potassium chloride formed in the reaction is removed by filtration. The obtained poly(ether sulfone) solution is then precipitated in water, the resulting poly(ether sulfone) beads are separated and then extracted with hot water (85° C.) for 20 h. Then the beads are dried at 120° C. for 24 h at reduced pressure (<100 mbar).

The presence of the 4,4′-biphenol derived units in the copolymer is verified by 1H-NMR spectroscopy. The obtained poly(ether phenylene sulfone) has a glass transition temperature (T_{G}) of 230.8° C., a viscosity number of 82.1 mL/g, a molecular weight M_{W} (GPC in THF, PS standard) of 74 450 g/mol and a polydispersity Mw/M_{N} of 3.6.

### 2) Synthesis of the Sulfonated Polyethersulfone-Polyphenylenesulfone Copolymer

From a reservoir sulfuric acid (96%) is provided to a reaction vessel in an amount needed to provide a solution with the targeted sulfonated poly(ether sulfone) concentration of 8% by weight. The temperature of the sulfuric acid is set to the sulfonation temperature. 50 kg of the above-obtained poly(ether sulfone) is dosed to the mixture within 10 to 30 minutes. The reaction mixture is stirred for another 90 minutes to completely dissolve the poly(ether sulfone). The reaction mixture is thereafter stirred for another 90 minutes. In a reservoir equipped with a stirrer and with a wall temperature of 15° C. a liquid L1 is prepared from 3 125 L deionized water and nitric acid so that the nitric acid concentration in the liquid L1 is 0.27% by weight, based on the liquid L1.

As dynamic inline mixing device a one-stage rotor-stator tooth rim dispersion machine with a concave rotor is used (Cavitron® CD1010, with a cone mixing system; Verfahrenstechnik v. Hagen & Funke GmbH, Sprockhövel, Germany). The dynamic inline mixing device functions as a pump which due to operating it at maximum rotational speed of up to 12 000 rpm. It draws the liquid L1 from the reservoir, whereby the inline mixing device operates in recirculation loop operation. While the three-way valve is set to the sulfuric acid reservoir, the gear pump is started to pump the sulfuric acid to the dynamic inline mixer and flushing the piping while doing this. After the connecting pipes are purged by the sulfuric acid, the respective sulfonated poly(ether sulfone) solution is fed to the dynamic inline mixing device by opening the three-way valve towards the reaction vessel containing the sulfonated poly(ether sulfone) solution and pumping it into the dynamic inline mixer. Upon the contacting of the respective sulfonated poly(ether sulfone) solution with the liquid L1 a suspension is obtained. The suspension is recirculated into the reservoir of liquid L1 whereby its solid content increased continually. To avoid settling, the suspension is stirred in the reservoir. The liquid L1 and the suspension respectively are passed through the dynamic inline mixing device in an amount of about 75 L/min. The temperature of the suspension in the reservoir is monitored. In course of the process the temperature of the suspension rises by between 30 to 35° C. The suspension is recirculated until the respective sulfonated poly(ether sulfone) solution is used up. Thereafter the pipes are purged with the sulfuric acid.

The suspension is filtered through a Nutsche, whereby 1 bar pressure is applied. A filter with a nominal pore size of 10 μm is used. The filter cake is washed with about 800 L of deionized water with a temperature of about 40° C. per washing is used. The washing is interrupted as soon as the filtrate water has a pH of 4 or higher. Typically, not more than six washings are carried out. Thereafter, the obtained respective sulfonated poly(ether sulfone) is dried in the Nutsche under vacuum at 55 to 60° C. until a residual water content of below 2% by weight, based on the weight of the sulfonated poly(ether sulfone), is obtained.

The sulfonated polyether sulfone polymer has a viscosity number of 86.3 mL/g, a molecular weight Mw (GPC in THF, PS standard) of 72 400 g/mol, a polydispersity of M_{W}/M_{N}=3.6 and an Ion Exchange Capacity IEC of 0.210 meq/g.

### Synthesis of the Sulfonated Polyphenylene Sulfone: sP2 (Component (A2)):

In a 4 liter glass reactor fitted with a thermometer, a gas inlet tube and a Dean-Stark-trap, 557.09 g (1.94 mol) of 4,4′-dichlorodiphenylsulfone (DCDPS; CAS 80-07-9)), 372.42 g (2.00 mol) of 4,4′-dihydroxydiphenylsulfone (DHDPS; CAS 92-88-6)), 70.15 g (0.1428 mol) of disodium-bis-(4-chloro-3-sulfophenyl)-sulfone (sDCDPS; CAS 51698-33-0) and 317.83 g (2.3 mol) of potassium carbonate with a volume average particle size of 33.2 μm are suspended in 1250 mL NMP (N-methyl-2-pyrrolidone; CAS 872-50-4) in a nitrogen atmosphere. The mixture is heated to 190° C. within one hour. In the following, the reaction time shall be understood to be the time during which the reaction mixture is maintained at 190° C. The water formed in the reaction is continuously removed by distillation. The evaporated solvent is replaced. After a reaction time of 7 hours, the reaction is stopped by the addition of 500 mL NMP and cooled down to room temperature (within one hour). The potassium chloride formed in the reaction is removed by filtration. The obtained sulfonated poly(phenylene sulfone) solution is then precipitated in water, the resulting sPPSU beads are separated and then extracted with hot water (85° C.) for 20 h. Then the beads are dried at 120° C. for 24 h at reduced pressure (<100 mbar).

The presence of 5.3 mol % sulfonated units derived from disodium-bis-(4-chloro-3-sulfophenyl)-sulfone units (x=0.053) in the copolymer is verified by 1H-NMR spectroscopy. The obtained sulfonated polyphenylene sulfone has a viscosity number of 62.7 mL/g and a calculated Ion Exchange Capacity IEC of 0.260 meq/g.

### P (Component (B)):

### Non-Sulfonated Poly(Arylene Sulfone) Polymer:

### Poly(Ether Sulfone)

Ultrason® E 6020 P; BASF SE; Viscosity number: 81 cm³/g (determined according to ISO 307; in 0.01 g/mL phenol/1,2-orthodichlorobenzene, 1:1 solution); Glass transition temperature T_{G}: 225° C. (determined according to ISO 11357-1/-2, DSC, 10° C./min); Molecular weight M_{W}: 75 000 g/mol (determined by GPC in THF, PS standard); Polydispersity M_{W}/M_{N}: 3.4

### Pore Forming Additive (Component (C₁)):

### Poly(Vinyl Pyrrolidone)

Luvitec® K90; BASF SE; Molecular weight M_{W}>900 000 g/mol; solution viscosity characterised by the K-value of 90 (determined according to the method of Fikentscher (Fikentscher, Cellulosechemie 13, 1932 (58)))

### Pore Forming Additive (Component (C2)):

Glycerol; Propane-1,2,3-triol [CAS 56-81-5]

### Solvent (Component (D)):

NMP; N-methyl-2-pyrrolidone [CAS 872-50-4]

### General Procedures

### Pure Water Permeation (PWP)

The pure water permeation (PWP) of the membranes is tested using a pressure cell with a diameter of 74 mm using ultrapure water (salt-free water, filtered by a Millipore UF-system) at 23° C. and 1 bar water pressure. The pure water permeation (PWP) is calculated as follows (equation 1):

$$PWP = \frac{m}{A \times P \times t} \qquad ( 1 )$$

PWP: pure water permeance [kg/bar h m²]
m: mass of permeated water [kg]
A: membrane area [m²]
P: pressure [bar]
t: time of the permeation experiment [h].

A high PWP of more than 50 kg/hm² bar allows a high flow rate and is desired.

### MWCO (Molecular Weight Cut-Off)

In a subsequent test, solutions of polyethylene oxide-standards with increasing molecular weight are used as feed to be filtered by the membrane at a pressure of 0.15 bar. By gel permeation chromatography (GPC) measurement of the feed and permeate, the molecular weight of the permeate of each polyethylene oxide-standard used is determined. The weight average molecular weight (M_{W}) cut-off of the membranes (MWCO) is the molecular weight of the first polyethylene oxide standard that is withhold to at least 90% by the membrane. For example, a MWCO of 18 400 means that polyethylene oxides of a molecular weight of 18 400 g/mol and higher are withhold to at least 90%. It is desired to have a MWCO in the range from 5 to 100 kDa.

### Viscosity

The polymer solution viscosity is measured with a Brookfield Viscometer DV-I Prime (Brookfield Engineering Laboratories, Inc. Middleboro, USA) with RV 6 spindle at 60° C. with 20 rpm.

### Turbidity

The polymer solution turbidity is measured at 60° C. with a turbidimeter 2100AN (Hach Lange GmbH, Düsseldorf, Germany) employing a filter of 860 nm and expressed in nephelometric turbidity units (NTU). Low NTU values are preferred.

PVPₜₒₜₐₗ and PVP_{surface}

The poly(vinyl pyrrolidone) content of the membranes (PVPₜₒₜₐₗ) is determined by dissolving the membrane sample in N,N-dimethylformamide (DMF) and casting the solution as film on KRS-5 windows of thalliumbromiodide. The films are dried at 160° C. and analyzed with a Nicolet 6700 FT-IR spectrometer (Thermo Fischer Scientific, Waltham, Massachusetts, USA). Together with calibration samples of known poly(vinyl pyrrolidone) content, the adsorption band at 1680 cm⁻¹ is used to determine the overall poly(vinyl pyrrolidone) content of the membrane samples. The poly(vinyl pyrrolidone) content of the membranes surface (PVP_{surface}) is estimated with the same adsorption band by attenuated infrared spectroscopy (ATR) and reference samples.

### Preparation of Membranes

### Comparative Example C1-M

As given in table 1, into a three-neck flask equipped with a magnetic stirrer 19 g non-sulfonated poly(ether sulfone) (component (B)), 6 g poly(vinyl pyrrolidone) (component (C1)), 10 g glycerol (component (C2) and 65 g of NMP (component (D)) are added. The mixture is heated under gentle stirring at 60° C. until a homogeneous clear viscous solution(S) is obtained. The solution(S) is degassed overnight at room temperature. After that, the solution(S) is reheated at 60° C. for 2 hours and casted onto a glass plate with a casting knife (300 microns) at 60° C. using an Erichsen Coating machine (Coatmaster 510, Erichsen GmbH & Co KG, Hemer, Germany) operating at a speed of 5 mm/s to obtain a film of the solution(S). The film of the solution(S) is allowed to rest for 30 seconds before immersion in a water-based coagulation bath (60% by weight water/40% by weight glycerol) at 25° C. for 10 minutes to obtain a membrane (M1). After the membrane (M1) is detached from the glass plate, the membrane (M1) is transferred into a bath comprising 2 000 ppm NaOCl at 60° C. and a pH of 9.5 for 2 h. Subsequently the membrane (M1) is washed with water at 60° C. to obtain the membrane (M), and one time with a 0.5 wt.-% solution of sodium bisulfite to remove active chlorine.

### Inventive Examples 12-M to 15-M

Into a three-neck flask equipped with a magnetic stirrer sulfonated poly(ether sulfone) polymer (component (A1)) and non-sulfonated poly(ether sulfone) (component (B)) in the amounts given in table 1, 6 g poly(vinyl pyrrolidone) (component (C1)), 10 g glycerol (component (C2)) and 65 g of NMP (component (D)) are added. The mixture is heated under gentle stirring at 60° C. until a homogeneous clear viscous solution(S) is obtained (step a)). The solution(S) is degassed overnight at room temperature. After that, the solution(S) is reheated at 60° C. for 2 hours and casted onto a glass plate with a casting knife (300 microns) at 60° C. using an Erichsen Coating machine (Coatmaster 510, Erichsen GmbH & Co KG, Hemer, Germany) operating at a speed of 5 mm/s to obtain a film of the solution(S) (step b-1)). The film of the solution(S) is allowed to rest for 30 seconds before immersion in a water-based coagulation bath (60% by weight water/40% by weight glycerol) at 25° C. for 10 minutes to obtain a membrane (M1) (step b-2)). After the membrane (M1) is detached from the glass plate, the membrane (M1) is transferred into a bath comprising 2 000 ppm NaOCl at 60° C. and a pH of 9.5 for 2 h. Subsequently the membrane (M1) is washed with water at 60° C. to obtain the membrane (M) (step b-3)), and one time with a 0.5 wt.-% solution of sodium bisulfite to remove active chlorine.

The compositions and properties of the solutions(S), as well as of the prepared membranes (M), are shown in table 1.

TABLE 1

| | | | | | | | | PWP | | PVPₜₒₜₐₗ | PVP_{surface} |
|---|---|---|---|---|---|---|---|---|---|---|---|
| | (A1) | (B) | (C1) | (C2) | (D) | Viscosity | Turbidity | [kg/ | MWCO | [% by | [% by |
| Example | [g] | [g] | [g] | [g] | [g] | [Pas] | [NTU] | hm²bar] | [kDa] | weight] | weight] |
| C1-M | — | 19 | 6 | 10 | 65 | 31.8 | 0.832 | 630 | 29.4 | 0.77 | 1.0 |
| I2-M | 1.9 | 17.1 | 6 | 10 | 65 | 29.8 | 0.862 | 550 | 30.0 | 0.84 | 1.5 |
| I3-M | 4.75 | 14.25 | 6 | 10 | 65 | 30.0 | 1.05 | 210 | 22.6 | 1.99 | 6.7 |
| I4-M | 9.5 | 9.5 | 6 | 10 | 65 | 31.5 | 1.22 | 77 | 11.2 | 2.70 | 7.5 |
| I5-M | 14.25 | 4.75 | 6 | 10 | 65 | 28.0 | 1.95 | 96 | 15.2 | 4.58 | 12.8 |

As can be seen from table 1, the inventive membranes (M) (I2-M to I5-M) show all a high pure water permeation of 50 to 600 kg/h m² bar and a MWCO of 11.2 to 30 kDa. With increasing sulfonated poly(ether sulfone) polymer (component (A)) content, the inventive membranes (M) exhibit increasing PVP contents (PVPₜₒₜₐₗ and PVP_{surface}) which means that the inventive membranes (M) withhold PVP in the membrane matrix, and, therefore, prevent the leaching out of PVP of the membrane matrix.

FIG. 1 shows a cross-section of the membrane of inventive example 12-M and FIG. 2 shows a cross-section of the membrane of comparative example C1-M (1500×magnification). As can be seen from the figures, the membrane according to the invention shows a well-established nano porous filtration layer with no defects or macro voids. The membrane according to comparative example C1-M shows numerous macro voids and defects that could partially penetrate the filtration layer on the top.

### Inventive Examples 16-M to 18-M

Into a three-neck flask equipped with a magnetic stirrer sulfonated poly(phenylene sulfone) polymer (component (A2)) and non-sulfonated poly(ether sulfone) (component (B)) in the amounts given in table 2, 6 g poly(vinyl pyrrolidone) (component (C1)), 10 g glycerol (component (C2)) and 65 g of NMP (component (D)) are added. The mixture is heated under gentle stirring at 60° C. until a homogeneous clear viscous solution(S) is obtained (step a)). The solution(S) is degassed overnight at room temperature. After that, the solution(S) is reheated at 60° C. for 2 hours and casted onto a glass plate with a casting knife (300 microns) at 60° C. using an Erichsen Coating machine (Coatmaster 510, Erichsen GmbH & Co KG, Hemer, Germany) operating at a speed of 5 mm/s to obtain a film of the solution(S) (step b-1)). The film of the solution(S) is allowed to rest for 30 seconds before immersion in a water-based coagulation bath (60% by weight water/40% by weight glycerol) at 25° C. for 10 minutes to obtain a membrane (M1) (step b-2)). After the membrane (M1) is detached from the glass plate, the membrane (M1) is transferred into a bath comprising 2 000 ppm NaOCl at 60° C. and a pH of 9.5 for 2 h. Subsequently the membrane (M1) is washed with water at 60° C. to obtain the membrane (M) (step b-3)), and one time with a 0.5 wt.-% solution of sodium bisulfite to remove active chlorine.

The compositions and properties of the solutions(S), as well as of the prepared membranes (M), are shown in table 2.

TABLE 2

| | | | | | | | | PWP | | PVPₜₒₜₐₗ | PVP_{surface} |
|---|---|---|---|---|---|---|---|---|---|---|---|
| | (A2) | (B) | (C1) | (C2) | (D) | Viscosity | Turbidity | [kg/ | MWCO | [% by | [% by |
| Example | [g] | [g] | [g] | [g] | [g] | [Pas] | [NTU] | hm²bar] | [kDa] | weight] | weight] |
| I6-M | 1.9 | 17.1 | 6 | 10 | 65 | 29.0 | 1.7 | 580 | 28.0 | 0.81 | 1.9 |
| I7-M | 4.75 | 14.25 | 6 | 10 | 65 | 25.7 | 1.0 | 300 | 20.5 | 2.26 | 6.3 |
| I8-M | 9.5 | 9.5 | 6 | 10 | 65 | 24.4 | 1.2 | 125 | 10.7 | 4.25 | 10.2 |
| C1-M | — | 19 | 6 | 10 | 65 | 31.8 | 0.832 | 630 | 29.4 | 0.77 | 1.0 |

As can be seen from table 2, the inventive membranes (M) (I6-M to I10-M) show all a high pure water permeation of 50 to 600 kg/h m² bar and a MWCO of 10.7 to 28 kDa. With increasing sulfonated poly(phenylene ether sulfone) polymer (component (A2)) content, the inventive membranes (M) exhibit increasing PVP contents (PVPₜₒₜₐₗ and PVP_{surface}) which means that the inventive membranes (M) withhold PVP in the membrane matrix, and, therefore, prevent the leaching out of PVP of the membrane matrix.

1.-16. (canceled)

17. A method for the preparation of a membrane (M), the membrane (M) comprising
(A) a sulfonated poly(arylene ether sulfone) polymer (sP) and
(B) a non-sulfonated poly(arylene sulfone) polymer (P),
wherein the method comprises at least steps a) and b):
a) providing a solution(S) which comprises the sulfonated poly(arylene ether sulfone) polymer (sP) according to component (A), the non-sulfonated poly(arylene sulfone) polymer (P) according to component (B), at least one pore forming additive (C) and at least one solvent (D), wherein the at least one pore forming additive (C) comprises poly(vinyl pyrrolidone), and
b) separating the at least one pore forming additive (C) and the at least one solvent (D) from the solution(S) to obtain the membrane (M),
wherein the solution(S) in step a) comprises from 0.5 to 20% by weight of the sulfonated poly(arylene ether sulfone) polymer (sP), from 0.5 to 20% by weight of the non-sulfonated poly(arylene sulfone) polymer (P), from 3 to 20% by weight of the at least one pore forming additive (C) and from 40 to 96% by weight of the at least one solvent (D), based in each case on the total weight of the solution(S), wherein the at least one pore forming additive (C) comprises in the range from 17 to 75% by weight of poly(vinyl pyrrolidone) and in the range from 25 to 83% by weight of at least one alcohol,
and wherein the separation of the at least one pore forming additive (C) and the at least one solvent (D) from the solution(S) is carried out via a phase inversion process.

18. The method according to claim 17, wherein the sulfonated poly(arylene ether sulfone) polymer (sP) comprises units of formula (I) 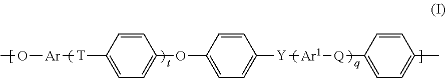
where
t and q: are each independently 0, 1, 2 or 3,
Q, T and Y: are each independently a chemical bond or a group selected from —O—, —S—, —SO₂—, —S(═O)—, —(C═O)—, —N═N— and —CR^{a}R^{b}—, wherein R^{a} and R^{b} are each independently a hydrogen atom or a C₁-C₁₂ alkyl, C₁-C₁₂ alkoxy or C₆-C₁₈ aryl group, and where at least one of Q, T and Y is —SO₂— and
Ar and Ar¹: are each independently an arylene group having from 6 to 18 carbon atoms and where
at least one unit (I) comprises an arylene group which is substituted with at least one —SO₂X group, wherein X is selected from the group consisting of Cl and O combined with one cation equivalent, where the cation equivalent is H⁺, Li⁺, Na⁺, K⁺, Mg²⁺, Ca²⁺ or NH₄⁺.

19. The method according to claim 17, wherein the sulfonated poly(arylene ether sulfone) polymer (sP)
i) comprises units of formula (III) 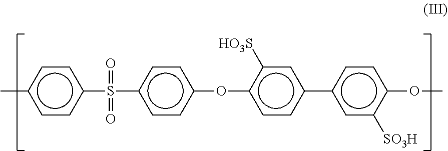
and/or formula (IV) 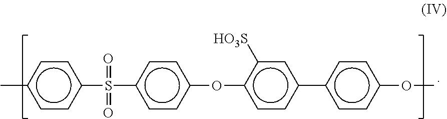
and/or
ii) has a number-average molecular weight (M_{N}) of from 10 000 to 35 000 g/mol, and/or
iii) has a content of free acid of less than 3 mg KOH/g sulfonated poly(arylene ether sulfone) polymer (sP).

20. The method according to claim 17, wherein the sulfonated poly(arylene ether sulfone) polymer (sP) comprises units of formula (V) 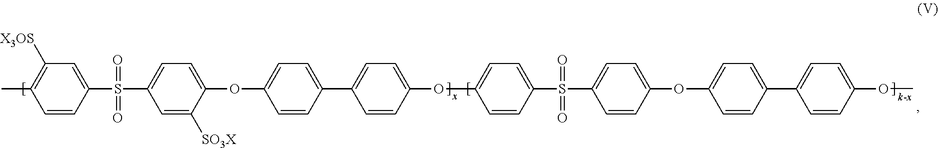
wherein x is in the range of 0.01 to 1 and x+k is 1.

21. The method according to claim 17, wherein the non-sulfonated poly(arylene sulfone) polymer (P) comprises units of formula (II) 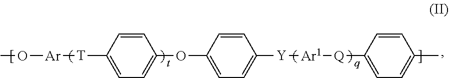
where
t and q: are each independently 0, 1, 2 or 3,
Q, T and Y: are each independently a chemical bond or a group selected from —O—, —S—, —SO₂—, —(S═O)—, —(C═O)—, —N═N— and —CR^{a}R^{b}—
wherein R^{a} and R^{b} are each independently a hydrogen atom or a C₁-C₁₂-alkyl, C₁-C₁₂-alkoxy or C₆-C₁₈-aryl group, and where at least one of Q, T and Y is —SO₂— and
Ar, Ar¹: are each independently an arylene group having from 6 to 18 carbon atoms.

22. The method according to claim 23, wherein the non-sulfonated poly(arylene sulfone) polymer (P) is
i) a poly(ether sulfone) and comprises units of formula (Ik) 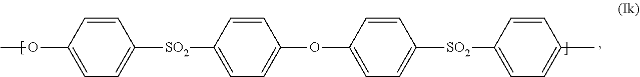
or
ii) a polysulfone and comprises units of formula (Ia) 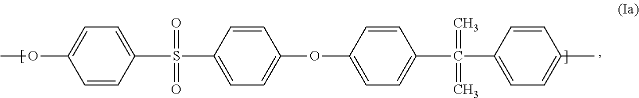
or
iii) a polyphenylene sulfone and comprises units of formula (Ig)

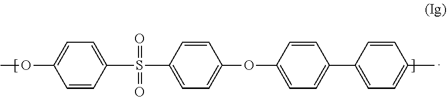

23. The method according to claim 17, wherein the at least one solvent (D) is selected from the group consisting of N-alkyl-2-pyrrolidone, preferably N-methyl-2-pyrrolidone, N-ethyl-2-pyrrolidone, N-butyl-2-pyrrolidone and N-tert.-butyl-2-pyrrolidone, 2-pyrrolidone, N,N-dimethylacetamide, dimethylsulfoxide, dimethylformamide, N,N-dimethyl-2-hydroxypropan amide, N,N-diethyl-2-hydroxypropan amide, y-valerolactone, dihydrolevoglucosenone, methyl 5-(dimethylamino)-2-methyl-5-oxopentanoate and sulfolane.

24. The method according to claim 17, wherein the at least one pore forming additive (C) comprises glycerol as the at least one alcohol.

25. The method according to claim 17, wherein step b) comprises the following steps:
b-1) casting the solution(S) provided in step a) to obtain a film of the solution(S),
b-2) immersing the film of the solution(S) into at least one protic polar solvent, wherein the sulfonated poly(arylene ether sulfone) polymer (sP) and the non-sulfonated poly(arylene sulfone) polymer (P) comprised in the film of the solution(S) are at least partly separated from the at least one pore forming additive (C) and the at least one solvent (D) comprised in the film of the solution(S) to obtain a membrane (M1) which is in the form of a film, and
b-3) washing the membrane (M1) with water, wherein the sulfonated poly(arylene ether sulfone) polymer (sP) and the non-sulfonated poly(arylene sulfone) polymer (P) comprised in the membrane (M1) are essentially completely separated from the at least one pore forming additive (C) and the at least one solvent (D) comprised in the membrane (M1) to obtain the membrane (M).

26. The method according to claim 25, wherein the at least one protic polar solvent is a water-based coagulation bath.

27. The method according to claim 25, wherein step b-1) is carried out at a temperature in the range of 40 to 80° C.

28. A membrane prepared by a method according to claim 17, wherein the membrane (M) is a porous membrane (M) and has a poly(vinyl pyrrolidone) content PVPₜₒₜₐₗ in the range from 0.8 to 5% by weight, based on the total weight of the membrane (M).

29. The membrane (M) according to claim 28, wherein the membrane (M)
i) has a molecular weight cut-off in the range from 10 to 30 kDa, and/or
ii) has a pure water permeation of >50 kg/(h m² bar), and/or
iii) is asymmetric.

30. The membrane (M) according to claim 28, wherein the membrane (M) comprises from 5 to 90% by weight of the sulfonated poly(arylene ether sulfone) polymer (sP), based on the total weight of the membrane (M).

31. Use of a membrane (M) according to claim 28 as ultrafiltration membrane.
